(19) United States
(12) Patent Application Publication
(10) Pub. No.: US 2003/0033737 A1
(43) Pub. Date: Feb. 20, 2003

(54) Pet tag holder

(76) Inventors: Jennifer Bradshaw, Greenfield, IN (US); Mark Bradshaw, Greenfield, IN (US)

Correspondence Address: David E. Novak, Woodard, Emhardt, Naughton, Moriarty and McNett, Bank One Center/Tower, 111 Monument Circle, Suite 3700, Indianapolis, IN, 46204-5137, US

(21) Appl. No.: 10/217,532

(22) Filed: Aug. 13, 2002

Related U.S. Application Data
(60) Provisional application No. 60/313,652, filed on Aug. 20, 2001.

(51) Int. Cl. G09F 3/00; G09F 3/14; A62B 35/00

(52) U.S. Cl. 40/300; 40/665; 119/858

(57) ABSTRACT

A holder for securing, silencing and protecting pet tags to a typical pet collar is provided. The holder includes an opening at one end allowing insertion of pet tags therein and an attachment opening allowing attachment therethrough of pet tags to a pet collar. In the preferred embodiment the holder is made of a flexible material allowing insertion of multiple tags and tags larger than the opening.

This application claims priority to and incorporates by reference U.S. Provisional Application Serial No. 60/313,652 filed Aug. 20, 2001.

### FIELD OF THE INVENTION

The present invention relates generally to a pet tag holder for securing, silencing and protecting pet tags.

### BACKGROUND OF THE INVENTION

It is often necessary for a pet to wear more than one tag on a collar to comply with local licensing and vaccination ordinances and to have an identification tag in case of loss. The tags are frequently made of metal or some other rigid material which will withstand constant pet activity. The tags are usually attached to a ring on a pet's collar using an S-shaped hook or a ring. This results in a collar with multiple tags which rattle and jingle every time the pet moves. Additionally, especially active pets may damage or lose tags or render them illegible with dirt or wear.

Homemade remedies to this problem, such as taping the tags together, result in tags becoming sticky and illegible. Devices such as those depicted in U.S. Pat. No. 4,259,798 to McConnell and U.S. Pat. No. 4,739,566 to Smith typically include several components designed to secure tags. Frequently these components are small and pose a choking hazard to a pet should they become separated from the device. Other devices such as the pet tag cover disclosed in U.S. Pat. No. 6,367,426 to Schaible are engageable with a pet tag without first removing the tag from the pet's collar. While convenient, this particular design also may pose a choking hazard should it become disengaged from the pet tag. Thus, a method for securing and protecting multiple pet tags which can not easily be separated from the tags is desired.

### SUMMARY OF THE INVENTION

The invention is set forth in the claims below, and the following is not in any way to limit, define or otherwise establish the scope of legal protection. In general terms, the present invention relates to a device and method for securing and protecting multiple pet tags.

One object of the present invention is to provide a pet tag protection device capable of securing and silencing multiple pet tags. The device comprises a flexible sleeve having a first opening on one edge and a second opening on one face. Pet tags are inserted in the sleeve through the edge opening and secured to a pet collar by a securing means passing through the face opening and the tags.

Another object of the present invention is to provide a pet tag protection device capable of securing and silencing pet tags of various shapes and sizes.

Further objects, embodiments, forms, benefits, aspects, features and advantages of the present invention may be obtained from the present disclosure.

### BRIEF DESCRIPTION OF THE DRAWINGS

FIG. 1 is a perspective view of a pet tag holder according to one embodiment of the present invention.

FIG. 2 is a perspective view of the back of the pet tag holder shown in FIG. 1.

FIG. 3 is a partial cross-sectional view along line 13 of the pet tag holder shown in FIG. 1.

FIG. 4 is a partial cross sectional view of a pet tag holder according to one embodiment of the present invention engaged with a pet tag.

FIG. 5 is a partial cross sectional view of a pet tag holder according to one embodiment of the present invention engaged with a pet tag and a pet collar.

### DETAILED DESCRIPTION OF THE INVENTION

For the purposes of promoting an understanding of the principles of the invention, reference will now be made to the embodiments illustrated in the drawings and specific language will be used to describe the same. It will nevertheless be understood that no limitation of the scope of the invention is thereby intended, and alterations and modifications in the illustrated device and method and further applications of the principles of the invention as illustrated therein, are herein contemplated as would normally occur to one skilled in the art to which the invention relates.

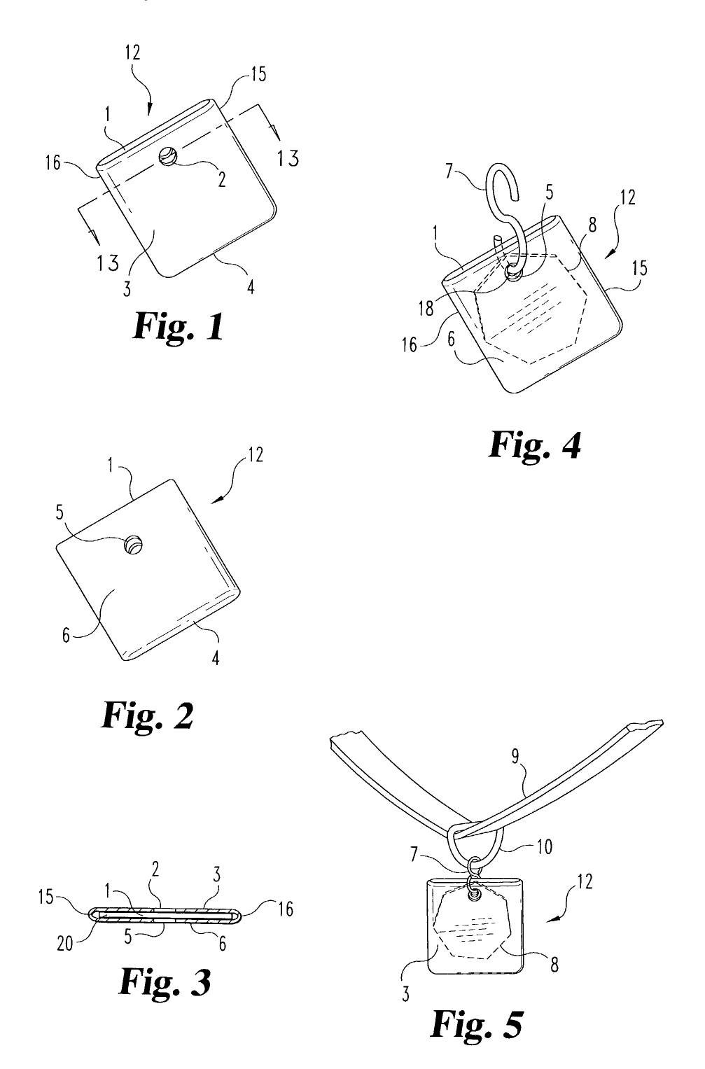

FIG. 1 shows a perspective view of a preferred embodiment of a pet tag holder 12 according to the present invention. Preferably the pet tag holder 12 is made of a somewhat flexible material such as plastic or rubber. Also preferably, the pet tag holder 12 is made of a transparent or semi-transparent material so as to allow a protected tag to be read without having to remove the tag from the tag holder. The pet tag holder 12 includes a front surface 3 and a rear surface 6 (as shown in FIG. 2). Connecting the front surface 3 and the rear surface 6 are a first side wall 15, a second side wall 16 and a closed end 4. These surfaces define a space or tag pouch 20 (as shown in FIG. 3) into which pet tags may be inserted through a tag opening 1 opposite the closed end 4.

The front surface 3 of the tag holder 12 further includes a front fastener opening 2. Although the front fastener opening 2 is depicted as circular, it is understood that other shapes and sizes may also be used to accommodate different types of pet tag fastening devices. Preferably, the front fastener opening 2 is located near the tag opening 1 so as to allow a single pet tag fastener to pass through the fastener opening and a pet tag as will be described in greater detail in the following paragraphs.

As seen in FIG. 2, the rear surface 6 of the pet tag holder includes a rear fastener opening 5. Although the rear fastener opening is depicted as circular, it is understood that other shapes and sizes may also be used to accommodate different types of pet tag fastening devices. Preferably, the rear fastener opening 5 is located near the tag opening 1 so as to allow a single pet tag fastener to pass through the fastener opening and a pet tag. Also preferably, the rear fastener opening 5 is aligned with the front fastener opening 2 so as to allow a single pet tag fastener to pass through the front fastener opening 2, a pet tag and the rear fastener opening 5 as will be described in greater detail in the following paragraphs.

FIG. 4 shows a perspective view of a pet tag 8 engaged with one preferred embodiment of the present invention 12. To insert the pet tag to be protected, preferably the first side wall 15 and the second side wall 16 are urged towards one another such as, for example, by squeezing the side walls between the thumb and forefinger. Moving the side walls 15,16 towards one another urges the front surface 3 and the rear surface 6 away from one another, thereby allowing easy insertion of the pet tag 8 into the tag pouch 20 through the tag opening 1. Preferably, the tag 8 to be protected is inserted into the tag pouch 20 until the tag fastener opening 18 is aligned with the front fastener opening 2 and the rear fastener opening 5. This allows a pet tag fastener 7 to be inserted through the front fastener opening 2, the tag fastener opening 18 and the rear fastener opening 5 thereby engaging the pet tag 8 and the tag holder 12. Once the pet tag fastener 7 is engaged with the pet tag 8 and the tag holder 12, the side walls may be released allowing the tag holder to move towards its original shape, thereby securing the pet tag 8 in the tag pouch 20. Preferably the tag holder 12 is made from a flexible material thereby allowing the insertion of tags which are larger than the tag opening 1.

The pet tag fastener 7 will preferably be an openable fastener such as the S-hook type fastener shown, although other styles of pet tag fasteners may also be used. Passing the pet tag fastener 7 through both the pet tag 8 and the tag holder 12 reduces the risk of the tag holder 12 becoming separated from the pet tag 8 and possibly presenting a choking hazard to the pet. Using an openable pet tag fastener 7 also allows the pet tag 8 to be inserted in the pet tag holder 12 and secured while still separate from the pet collar. This allows the user to secure the pet tag 8 in the pet tag holder without having to struggle with the movements of a pet. This ensures the pet tag 8 and pet tag holder 12 combination is properly secured by the openable pet tag fastener 7 prior to engagement with the pet collar.

As shown in FIG. 5, the pet tag 8 and tag holder 12 combination is attached to a pet collar 9 using the pet tag fastener 7. Typically, most standard pet collars include some sort of non-openable attachment member such as a D-ring 10, although the use of pet collars equipped with other styles of attachment members is also contemplated. Although the preceding discussion described the protection of a single pet tag, it is understood that the present invention also contemplates the insertion and protection of multiple pet tags in a single pet tag holder.

While the invention has been illustrated and described in detail in the drawings and foregoing description, the same is to be considered as illustrative and not restrictive in character, it being understood that only the preferred embodiment have been shown and described and that all changes and modifications that come within the spirit of the invention are desired to be protected. The articles “a”, “an”, “said” and “the” are not limited to a singular element, and include one or more such element.

What is claimed is:

1. In combination:
a pet collar having a non-openable attaching member;
a pet tag holder comprising a sleeve having an open end adapted to receive at least one pet tag and at least one opening adapted to receive an openable attaching member;
at least one pet tag inserted in said open end of said pet tag holder; and
an openable attaching member passing through said pet tag and said pet tag holder opening and attached to said non-openable attaching member.

2. The combination of claim 1, wherein said pet tag holder is made of a transparent material.

3. The combination of claim 1, wherein said pet tag holder is made of a flexible material.

4. The combination of claim 3, wherein said pet tag holder is adapted to receive pet tags larger than said open end.

5. A method of protecting pet tags, comprising:
providing a pet collar having a non-openable attaching member;
providing at least one pet tag;
providing a pet tag holder having an open end adapted to receive at least one pet tag and at least one opening adapted for receiving an openable attaching member;
inserting said at least one pet tag into said open end of said pet tag holder; and
attaching said pet tag holder and said at least one pet tag to said pet collar using an openable attaching member passing through said pet tag holder and said at least one pet tag and through said non-openable attaching member.
